(19) United States
(12) Patent Application Publication
(10) Pub. No.: US 2014/0292605 A1
(43) Pub. Date: Oct. 2, 2014

(54) REFLECTOR ANTENNA INCLUDING DUAL BAND SPLASHPLATE SUPPORT

(71) Applicant: ASTRIUM LIMITED, Stevenage, Hertfordshire (GB)

(72) Inventor: Richard William Roberts, Stevenage (GB)

(21) Appl. No.: 14/356,075

(22) PCT Filed: Oct. 30, 2012
(86) PCT No.: PCT/EP2012/071513

§ 371 Date: May 2, 2014

(30) Foreign Application Priority Data
Nov. 2, 2011 (EP) 11275137.5

(51) Int. Cl. H01Q 19/13

(52) U.S. Cl. CPC H01Q 19/134
USPC 343/781 CA

(57) ABSTRACT

A reflector antenna includes a dual-band waveguide feed and a splashplate support arranged to define a space between the waveguide feed aperture and the splashplate. The dual-band waveguide feed is configured to receive an input signal in a first transmission mode, to convert a transmission mode of an upper frequency band from a first transmission mode to a mixed transmission mode including the first transmission mode and a second transmission mode. The supporting portion can be spaced apart from the aperture of the waveguide feed, and may have a thickness corresponding to half a wavelength of a beam emitted from the aperture.

The present invention relates to a reflector antenna including a dual-band splashplate support. In particular, the present invention relates to a reflector antenna including a dual-band waveguide feed and a splashplate support arranged to define a space between the waveguide feed aperture and a splashplate of the reflector antenna.

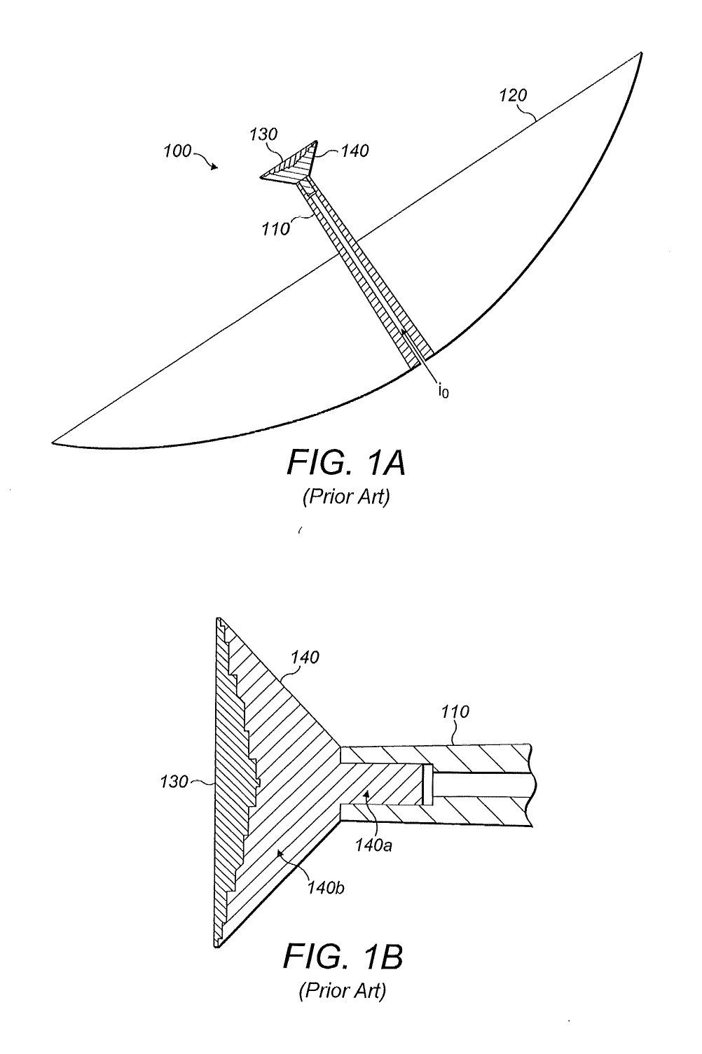

Reflector antennas are widely used, for example in land, airborne and naval terminals, and in communications satellites, to shape and direct a beam of electromagnetic radiation towards a particular location. A conventional reflector antenna 100 is illustrated in FIGS. 1A and 1B, and comprises a waveguide feed horn 110, a primary reflector 120, a splashplate 130 and a supporting dielectric 140 coupling the splashplate 130 to the waveguide feed 110. The feed horn 110 receives an input signal i₀ and directs the signal to an aperture of the feed horn 110. The signal is emitted from the aperture as a beam of electromagnetic radiation, and reflected by the splashplate 130 towards the primary reflector 120, which in turn shapes and directs the beam towards the desired location, for example a particular satellite or a geographical region on Earth. The feed horn 110, splashplate 130 and primary reflector 120 can be configured to shape the beam as required for a particular application.

As shown in FIG. 1B, the supporting dielectric 140 comprises an elongate portion 140a for inserting into a throat of the feed horn 110, and a conical portion 140b extending out from the elongate portion 140a towards the splashplate 130. The supporting dielectric 140 may itself be shaped internally and externally to provide the required radiation pattern and to minimise return losses. For example, the conical portion 140b may include various steps and grooves, and the portion inside the waveguide feed 140a may be stepped or profiled. However, the supporting dielectric 140 can only be specifically designed and optimised for a certain specific frequency or narrow band of frequencies. The conventional splashplate reflector antenna 100 is therefore unsuitable for use with wideband (e.g. >20% bandwidth) and/or dual-band applications, in which the beam to be shaped and directed includes a wide range of frequencies.

According to the present invention, there is provided a reflector antenna comprising a dual-band waveguide feed configured to receive an input signal in a first transmission mode, the input signal including a plurality of frequencies arranged into upper and lower frequency bands, and the waveguide feed including means for converting a transmission mode of the upper frequency band from a first transmission mode to a mixed transmission mode including the first transmission mode and a second transmission mode, a reflector, a splashplate configured to direct a beam emitted from an aperture of the waveguide feed to the reflector and a splashplate support comprising a first engaging portion for engaging with the waveguide feed, a second engaging portion for engaging with the splashplate, and a supporting portion connecting the first engaging portion to the second engaging portion, and arranged to define a space between the waveguide feed aperture and the splashplate.

The supporting portion may be configured to be spaced apart from the aperture of the waveguide feed in a direction away from the splashplate, when the first engaging portion is engaged with the waveguide feed.

The supporting portion may have a thickness less than or equal to substantially λ/2, where λ is a characteristic wavelength of the beam inside the supporting portion.

The characteristic wavelength may be a wavelength corresponding to a centre frequency of a transmission band of the beam emitted from the aperture of the waveguide feed, or an average wavelength of the beam, or a value between the average wavelength and the wavelength corresponding to the centre frequency.

The supporting portion may have a shape corresponding to a wavefront of the beam emitted from the waveguide feed after it has been reflected from the splashplate.

The supporting portion may be curved or elliptical in cross-section.

The supporting portion may be a substantially continuous wall.

The first engaging portion may be configured to engage with an outer surface of the waveguide feed.

The splashplate support may be formed of polytetrafluoroethylene PTFE.

The means for converting the transmission mode may be spaced apart from the aperture by a predetermined distance, such that for the upper band both the first and second transmission modes are substantially in phase at the aperture.

The means for converting the transmission mode of the upper frequency band may comprise a taper, one or more steps, or a profiled change in the internal diameter of the waveguide feed, and may connect a section of a first diameter D₁ to a section of a second diameter D₂, wherein the second diameter is greater than the first diameter.

The first transmission mode may be a TE₁₁ mode and the second transmission mode may be a TM₁₁ mode.

The waveguide feed may be circular in cross-section, and a diameter of the aperture may be substantially one wavelength of a frequency in the lower frequency band.

The waveguide feed may be configured for use at Ka band frequencies.

According to the present invention, there is also provided a satellite including the reflector antenna.

Embodiments of the present invention will now be described, by way of example only, with reference to the accompanying drawings, in which:

FIGS. 1A and 1B illustrate a conventional reflector antenna;

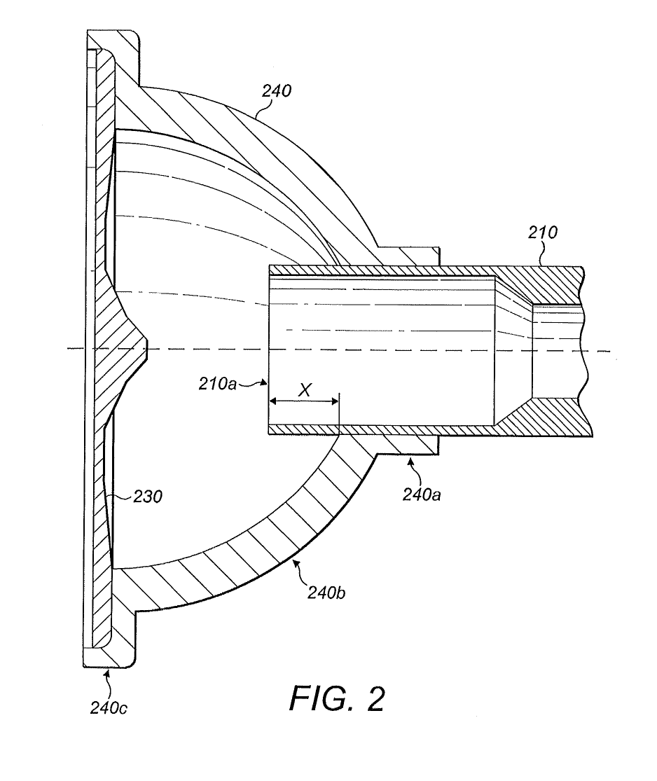

FIG. 2 illustrates a cross-section of a splashplate support for use in a reflector antenna, according to an embodiment of the present invention;

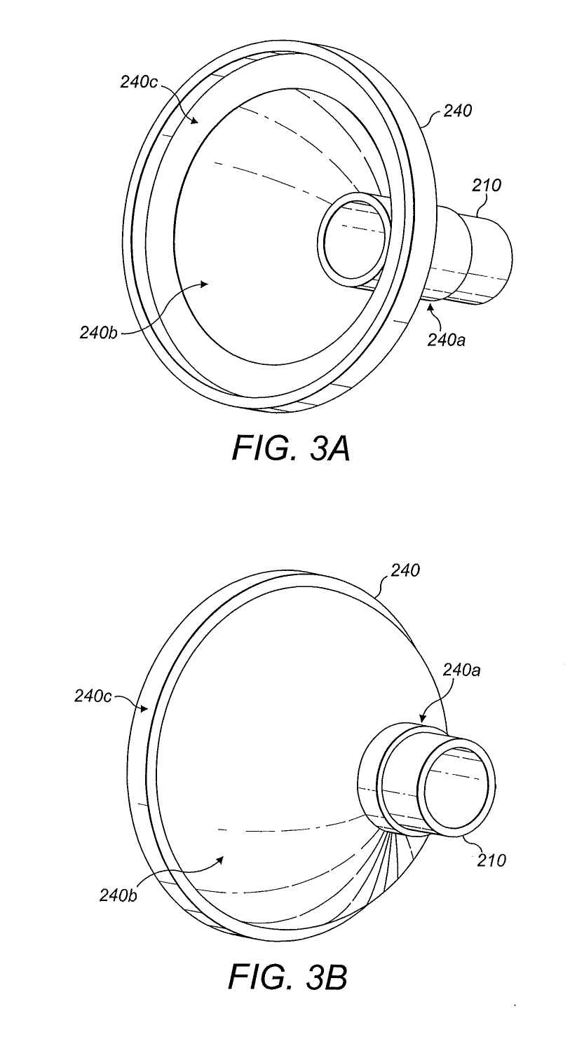

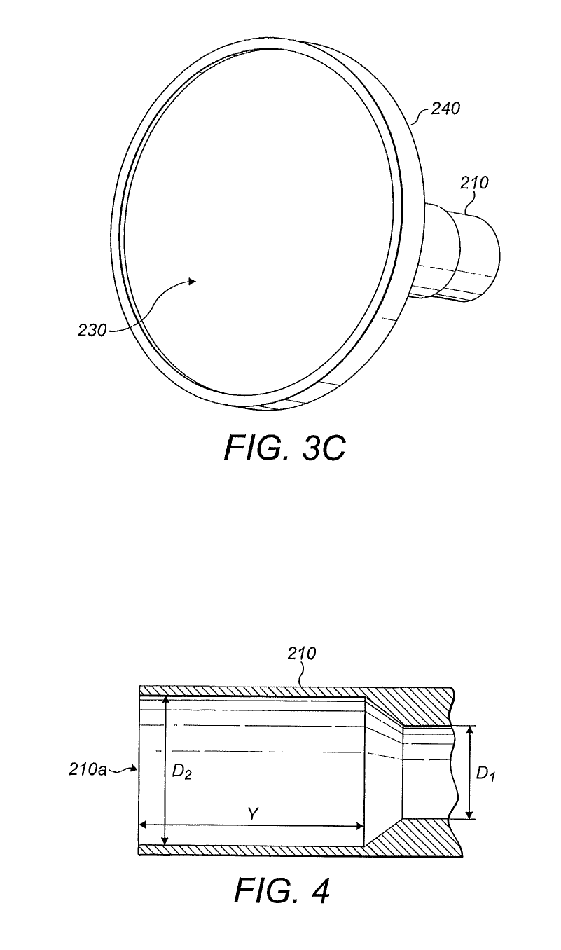

FIGS. 3A to 3C illustrate the splashplate support of FIG. 2, in perspective view;

FIG. 4 illustrates the waveguide feed of FIG. 2, in cross-section;

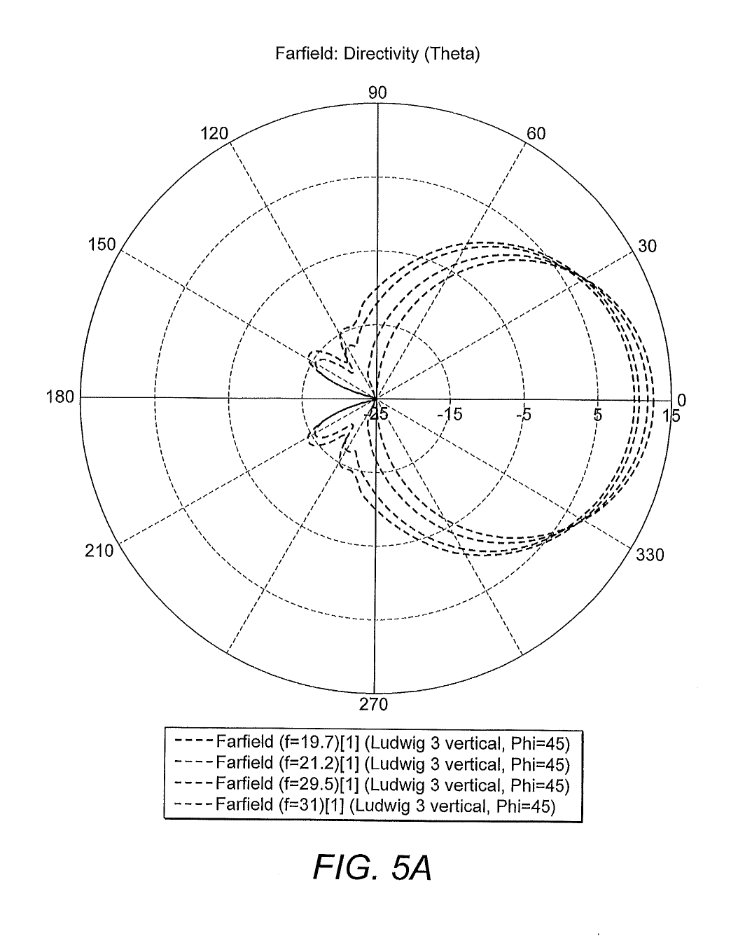

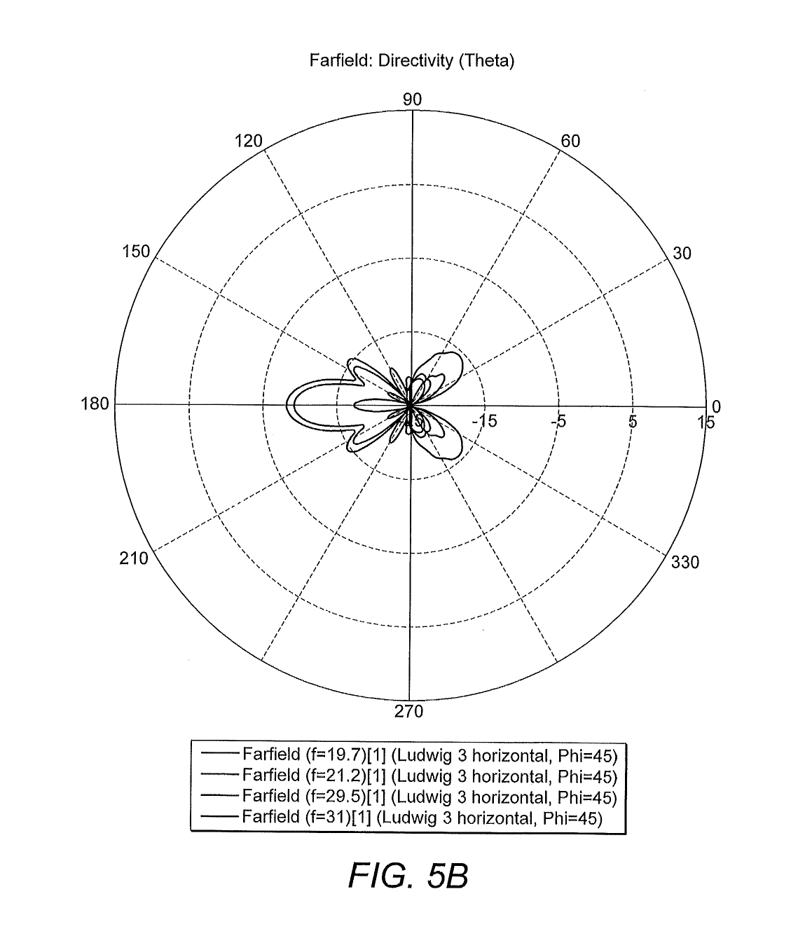

FIGS. 5A and 5B illustrate co-polar and cross-polar radiation patterns of the lower and upper frequency bands for the waveguide feed of FIG. 4;

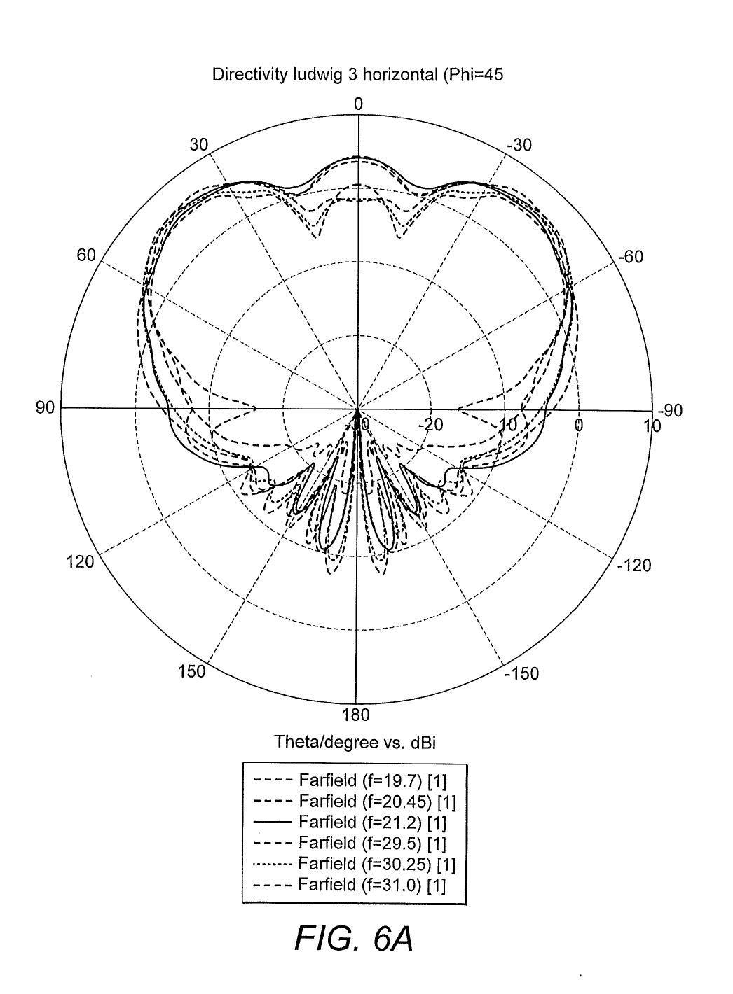

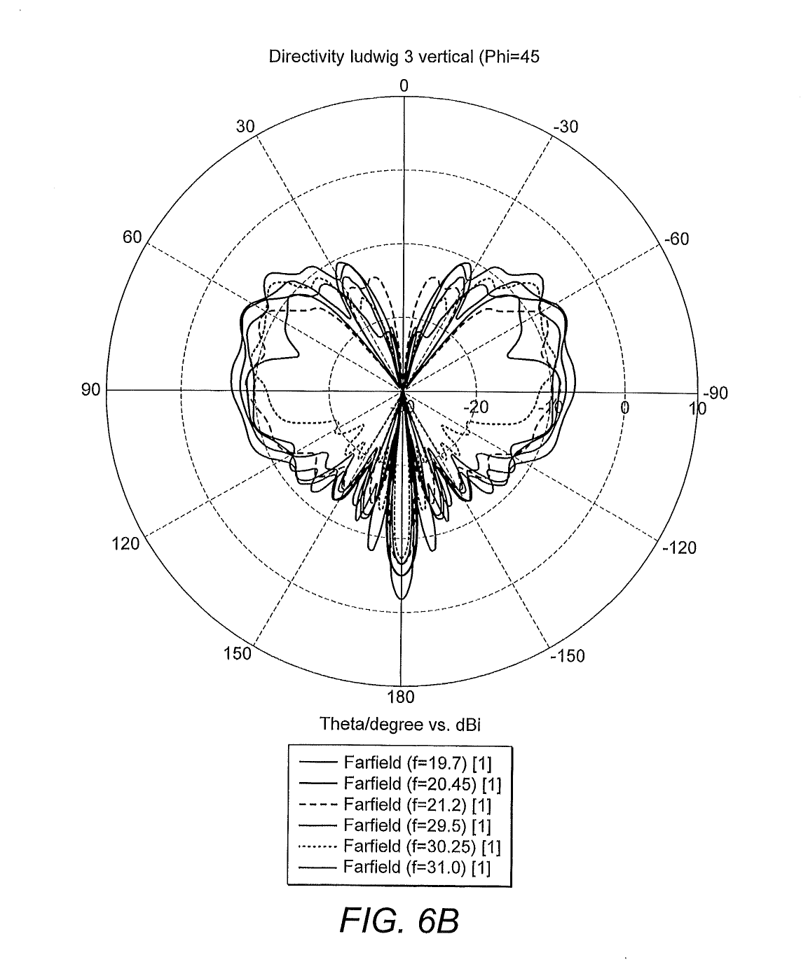

FIGS. 6A and 6B illustrate co-polar and cross-polar radiation patterns of the lower and upper frequency bands for the splashplate assembly of FIG. 2;

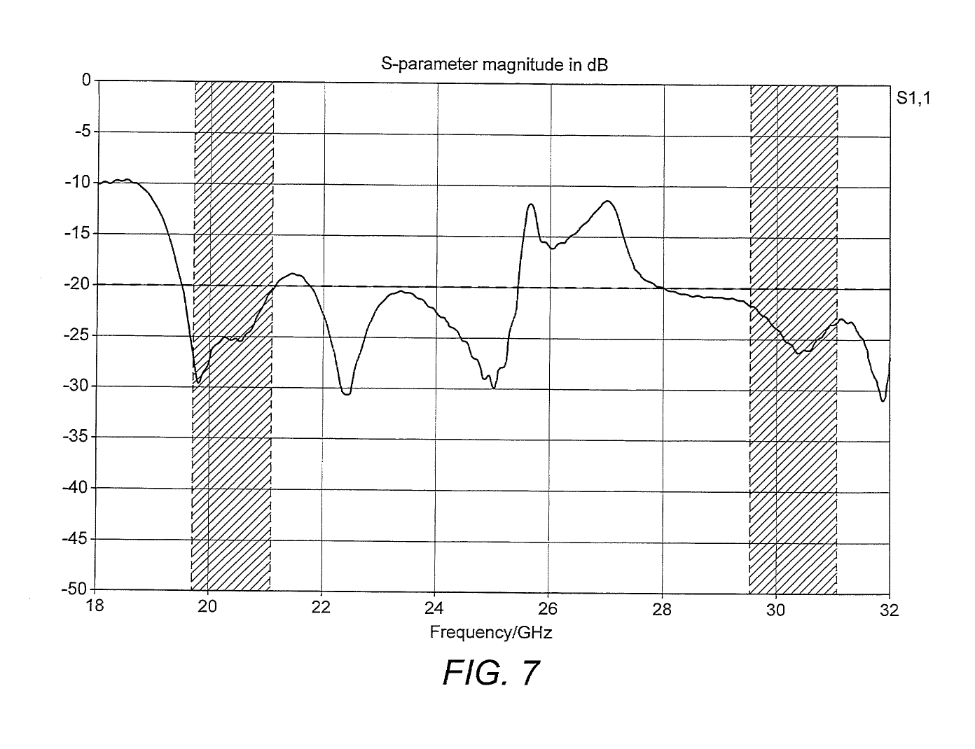

FIG. 7 is a graph of return loss against frequency covering the lower and upper frequency bands for the splashplate assembly of FIG. 2;

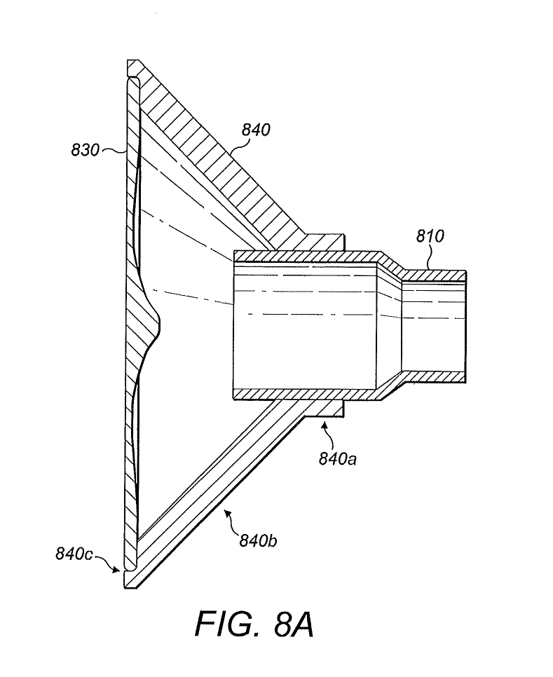

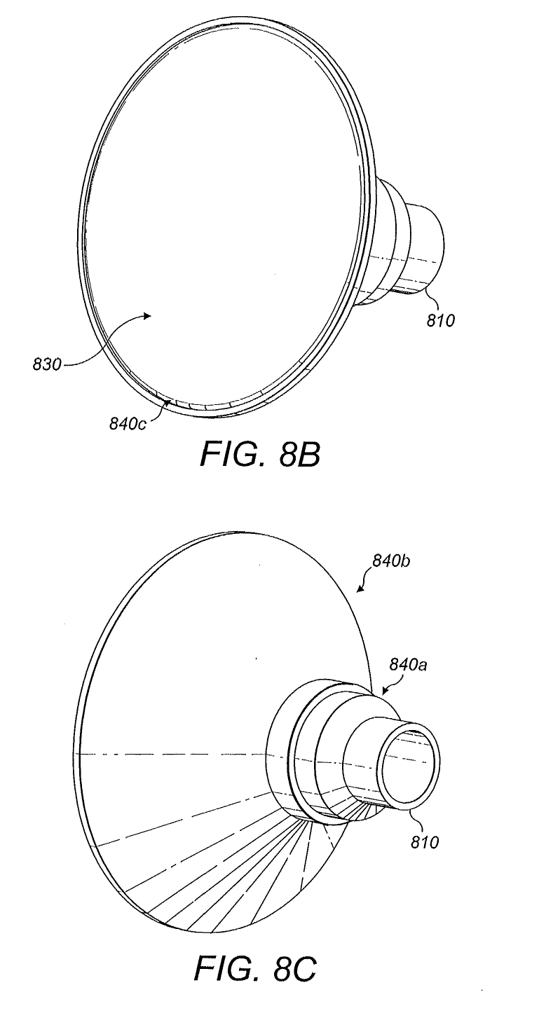

FIGS. 8A to 8C illustrate a splashplate support for use in a reflector antenna, according to a further embodiment of the present invention; and

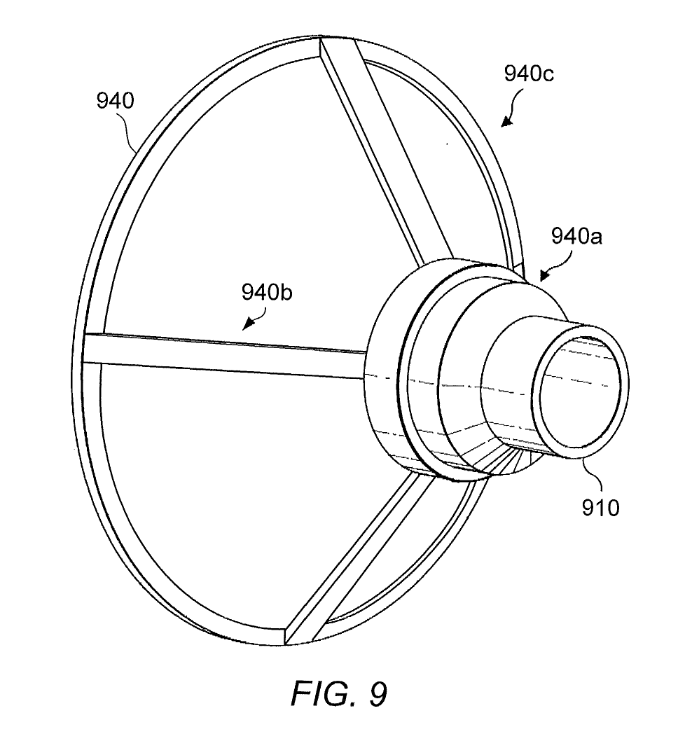

FIG. 9 illustrates a splashplate support comprising a plurality of supporting struts, according to yet a further embodiment of the present invention.

Referring now to FIG. 2, a splashplate assembly in a reflector antenna is illustrated in cross-section, according to an embodiment of the present invention. Here, the term ‘splashplate assembly’ refers to the waveguide feed 210, splashplate 230 and splashplate support 240. FIG. 2 and other ones of the accompanying drawings are not to scale, and are provided for illustrative purposes only. The reflector antenna comprises a waveguide feed 210, a splashplate 230, a splashplate support 240 and a primary reflector. The primary reflector is not shown in FIG. 2. The splashplate 230 is configured to direct a beam emitted from an aperture 210a of the waveguide feed 210 towards the primary reflector. Specifically, a beam emitted from the aperture 210a is reflected by the splashplate 230 towards the primary reflector, which in turn reflects the beam towards a destination. The primary reflector may be shaped to achieve a specified gain, cross-polar and sidelobe performance.

The waveguide feed 210 is configured to receive a dual-band input signal, i.e. a signal that includes a plurality of frequencies, wherein the frequencies are divided amongst two distinct transmission bands. The waveguide feed 210 and splashplate 230 are both formed of a material or materials that are electrically conductive at the frequencies for which the reflector antenna is designed. For example, the waveguide feed 210 and splashplate 230 can be formed of aluminium when the reflector antenna is designed for use at microwave frequencies. In the present embodiment, the waveguide feed is configured to receive an input signal including frequencies in the Kₐ band. Specifically, the input signal includes frequencies in a lower band from 19.7 to 212 gigahertz (GHz), and frequencies in a higher band from 29.5 to 31.0 GHz. However, these frequency ranges are merely exemplary, and the present invention is not limited to use in the Kₐ band. Other embodiments of the present invention may be configured for use at different frequencies.

The splashplate 230 can be configured to size, position and shape the beam emitted from the aperture 210a in order to produce a desired pattern for illumination of the reflector and to provide a good match (VSWR) in both bands. For example, the splashplate patterns can be ring focus in nature with the beam peak offset from the splashplate feed axis, which is illustrated as a dashed line in FIG. 2. This arrangement can enable sidelobes to be minimised in the reflected beam. Also, the waveguide feed 210 can be configured to produce similar feed patterns at the aperture in both the lower band and upper band as depicted in FIG. 5A. This can ensure that the splashplate patterns, i.e. the pattern of the beam after it is reflected from the splashplate 230, are similar for both the lower and upper bands, minimising a trade off between the bands in terms of reflector shaping and antenna performance.

In the present embodiment, the splashplate 230 is supported by a splashplate support 240 which comprises a first engaging portion 240a, a second engaging portion 240c, and a supporting portion 240b connecting the first and second engaging portions 240a, 240c such that the splashplate 230 can be supported in a predetermined position relative to the waveguide feed 210. In the present embodiment, the supporting portion 240b is formed as a continuous wall, and will hereinafter be referred to as a “supporting wall”. The first engaging portion 240a is configured to engage with the outer surface of the waveguide feed 210, and the second engaging portion 240c is configured to engage with an outer edge of the splashplate 230. In the present embodiment, the support 240 is formed from polytetrafluoroethylene (PTFE), having a dielectric constant of about 2.1.

However, the present invention is not limited to this material, and in general any low-dielectric constant material may be used for the support 240. As the dielectric constant is increased, the wall thickness should be decreased accordingly, and design sensitivity will increase. In the present embodiment, where the splashplate assembly is configured for use at Kₐ band frequencies, the relative permittivity εᵣ of the dielectric splashplate support 240 should be less than 4, and preferably less than 3. The present invention is not limited to this range of εᵣ for the splashplate support, and in other embodiments configured for use at different frequencies, other values of εᵣ may be appropriate. In some embodiments, a layered structure of different materials may be used to form the supporting wall 240b, in a similar manner to a radome (radar-dome) structure.

As shown in FIG. 2, the splashplate support 240 is hollow. That is, the supporting wall 240b is itself solid, but is shaped such that the support 240 and splashplate 230 define a space, or void, between the waveguide feed aperture 210a and the splashplate 230. In the present embodiment, as the supporting portion 240b is a continuous wall, the splashplate support 240 encloses the space.

The waveguide feed 210 extends through an opening in the supporting wall 240b and into the space. Because the support 240 is configured to engage with an outer surface of the waveguide feed 210, the hollow interior of the waveguide feed 210 can be kept free of dielectric. This maximises the bandwidth over which the waveguide feed 210 can be tuned to operate at two separate frequency bands simultaneously, and also enables the design process to be simplified by allowing items such as the waveguide feed to be optimised independently from the complete splashplate assembly. Furthermore, the hollow splashplate support has minimal impact on the radiation patterns, in contrast to conventional solid supports, and so the splashplate itself can initially be designed without having to consider the effect of the splashplate support. In contrast, a conventional splashplate support is restricted to use in a single frequency band due to the significant impact of the dielectric support, particularly inside the feed aperture. Also, the conventional splashplate assembly has to be designed as a complete assembly, necessitating a more complex and time-consuming design process.

Also, in the present embodiment the support 240 is configured such that when the first engaging portion 240a is engaged with the outer surface of the waveguide feed 210, the support 240 is spaced apart from the aperture 210a. Specifically, the first engaging portion 240a and supporting wall 240b are spaced apart from the aperture 210a by a distance X, in a direction away from the splashplate 230. Placing the support 240 external to the waveguide feed 210, and separating the support 240 from the aperture 210a in this way, prevents the dielectric body of the support 240 from interfering with the electromagnetic fields around the vicinity of the aperture 210a. Similarly, spacing the support 240 away from a central region of the splashplate 230 prevents the dielectric from interfering with fields around the electrically sensitive central region of the splashplate 230. The support 240 shown in FIG. 2 can therefore minimise losses and distortions in the splashplate patterns.

Although preferably the splashplate support 240 is configured to be spaced apart from the waveguide aperture 210a, as in the present embodiment, in other embodiments there may be no separation between the support and aperture once the splashplate support is engaged with the waveguide feed.

In the present embodiment the supporting wall 240b is configured to be substantially uniform in thickness. Preferably, the supporting wall 240b has a thickness of less than or equal to about λ/2, where λ is a characteristic wavelength of the beam within the dielectric material of the supporting wall 240b. In particular, a preferred range of thicknesses can be 0.4 to 0.6 λ, although in some embodiments other thickness could be used if necessary. Since a dual-band signal is input to the waveguide feed 210, there will be a range of wavelengths present in the beam. The characteristic wavelength could, for example, be a wavelength corresponding to a centre frequency of a transmission band of the beam emitted from the waveguide feed aperture, or could be an average wavelength of the beam, such as a mean wavelength of the plurality of wavelengths included in the beam. In the present embodiment, the characteristic wavelength is taken as a wavelength substantially midway between the upper and lower bands, i.e. a wavelength corresponding to a frequency between 25-26 GHz. Increasing the supporting wall 240b thickness will tune the splashplate support 240 towards the lower frequency band, at the expense of the upper frequency band.

The splashplate support 240 is illustrated in further detail in FIGS. 3A, 3B and 3C, which are front and rear perspective views of the splashplate support 240. As shown in FIG. 3A, the second engaging portion 240c is configured to receive and engage with the splashplate, which is omitted in FIG. 3A for clarity. Also, as shown in FIG. 3B, in the present embodiment the first engaging portion 240a is formed as a collar that is configured to be secured around the waveguide feed 210. FIG. 3C illustrates the splashplate support 240 with the splashplate 230 installed. Various methods may be used for securing the first engaging portion 240a to the waveguide feed 210, and for securing the second engaging portion 240c to the splashplate 230. For example, the first and second engaging portions 240a, 240c may be secured using an interference fit, snap fit, screw fit, adhesive, or mechanical fastenings such as screws. The first engaging portion 210a may be configured to be adjustable, such that the separation distance X between the support 240 and the aperture 210a (cf. FIG. 2) can be varied once the support, waveguide feed and splashplate have been assembled together.

The first and second engaging portions 240a, 240c are not limited to the forms shown in FIGS. 2, 3A, 3B and 3C, and in other embodiments the first and second engaging portions may be shaped differently. Also, although in the present embodiment the first and second engaging portions 240a, 240c and support wall 240b are integrally formed as a single body, in other embodiments they may be formed separately and then subsequently joined to form the support 240.

Preferably, the supporting wall is shaped to approximately correspond to the phase front of the radiated field from the splashplate. This allows the influence of the dielectric support on the patterns to be minimised, and hence enables the reflector antenna to be operated at wider transmission bands. In particular, the supporting wall position and thickness may be determined based on the return loss and crosspolar performance in both bands, and the supporting wall can be curved or profiled to suit. Although in the present embodiment the supporting wall 240b is formed to be substantially hemispherical and is based on an elliptical profile, the present invention is not limited to this particular design. For example, in another embodiment the supporting wall may be planar or geodesic. The supporting wall may be configured to minimise reflections and interference with the path of the beam through the supporting wall.

Referring now to FIG. 4, the dual-band waveguide feed of FIG. 2 is illustrated in cross-section. As described above with reference to FIG. 2, the dual-band waveguide feed 210 is configured to receive a dual-band input signal, i.e. a signal including a plurality of frequencies distributed amongst a first transmission band and a second transmission band. Specifically, the dual-band waveguide feed 210 is configured to receive the input signal in a first transmission mode, which in the present embodiment is a TE₁₁ mode. As shown in FIG. 4, the dual-band waveguide feed 210 includes means 210b for converting a transmission mode of the upper frequency band from a first transmission mode to a mixed transmission mode, the mixed transmission mode including the first transmission mode and a second transmission mode. In the present embodiment, the second transmission mode is a TM₁₁ mode. The means for converting the first transmission mode to the mixed transmission mode can be referred to as a “mode launcher” or “mode converter”. The mode launcher 210b is configured such that it does not significantly affect frequencies of the lower transmission band. Therefore at the aperture 210a, frequencies in the upper frequency band are propagated in the mixed transmission mode, i.e. TE₁₁+TM₁₁, and frequencies in the lower frequency band are propagated in the first transmission mode only, i.e. TE₁₁.

In more detail, in the present embodiment the mode launcher 210b comprises a tapered region inside the waveguide feed 210, in which the internal diameter of the waveguide feed 210 is increased from a first diameter D, to a second diameter D₂. The second diameter D₂, which is greater than the first diameter D₁, is the diameter of the waveguide aperture 210a. In the present embodiment, the diameter D₂ of the waveguide aperture 210a is approximately equal to the free space wavelength of signals in the lower frequency band. This ensures that at the aperture 210a, the TE₁₁ mode E & H plane patterns in the lower band are similar, and the resultant cross-polar is low.

The operation of the mode launcher 210b on frequencies in the upper frequency band will now be described. The relatively abrupt change in the diameter of the waveguide feed 210 at the mode launcher 210b results in the generation of a TM₁₁ mode, which propagates in the upper band only. Specifically, the relative diameters D₁ and D₂ are chosen to ensure that the cut-off frequency for the TM₁₁ mode falls between the upper and lower frequency bands. The size of the mode launcher 210b and the distance Y from the aperture 210a can be varied to control the electric fields at the waveguide aperture 210a, and can be selected to give an optimum mixed mode TE₁₁+TM₁₁ feed behaviour with uniform aperture fields and low edge field curvature, in a similar manner to a conventional dual-mode feed horn or Potter horn. In more detail, as shown in FIG. 4 the mode launcher 201b is spaced apart from the waveguide aperture 210a by a predetermined distance Y, which ensures that both the TE₁₁ and TM₁₁ modes in the upper band are substantially in phase at the aperture 210a. Specifically, a phase difference between the TE₁₁ mode and the TM₁₁ mode will vary according to the distance from the mode launcher 210b. The distance Y can therefore be selected such that the phase difference at the aperture 210a is close to zero, i.e. such that the TE₁₁ and TM₁₁ modes in the upper band are substantially in-phase at the aperture 210a.

Therefore by controlling the size and position of the mode launcher 210b, i.e. the internal diameters D₁ and D₂ and the separation Y from the waveguide aperture 210a, uniform field patterns can be achieved in both planes and the cross-polar component can be reduced. The lower band patterns can remain unaffected by the mode launcher 210b, although the return loss should still be considered for both bands when designing the mode launcher 210b. Although in the present embodiment the mode launcher 210b is formed as a tapered section of the waveguide feed 210, the present invention is not limited to this geometry. For instance, in other embodiments the mode launcher 210b may be formed as one or more steps in the internal diameter, or using some other profiled geometry such as a ridged geometry.

The features described above can ensure that the waveguide feed 210 has optimum and similar pattern performance in both the lower and the upper bands.

Although in the present embodiment, TM₁₁ and TE₁₁ modes are used, the present invention is not limited to this case. Other embodiments may be configured for use with other modes, for example the aperture size could be increased by about 40% to utilise the TE₁₂ mode. In some embodiments, a corrugated waveguide feed may be used.

FIG. 5A illustrates the co-polar radiation patterns for the lower and upper bands in the waveguide feed of FIG. 4, and FIG. 5B illustrates the cross-polar radiation patterns for the lower and upper bands in the waveguide feed of FIG. 4. Similarly, FIG. 6A illustrates the co-polar radiation patterns for the lower and upper bands in the splashplate assembly of FIG. 2, and FIG. 6B illustrates the cross-polar radiation patterns for the lower and upper bands in the splashplate assembly of FIG. 2. In FIGS. 5A, 5B, 6A and 6B, an angle of 0 degrees corresponds to the boresight direction, i.e. the direction in which the beam is emitted from the aperture and in which the transmitted beam is directed. As shown in FIGS. 5A, 5B, 6A and 6B, both upper and lower bands exhibit similar co- and cross-polar components in the forward direction. The waveguide feed patterns of FIGS. 5A and 5B are of primary interest out to about 60°, corresponding to the angle subtended by the splashplate, and have beam peaks on boresight at 0°. The splashplate assembly patterns of FIGS. 6A and 6B are of primary interest out to about 80° and have co-polar peaks that are nominally off-axis in a direction between 30° and 60°.

Referring now to FIG. 7, a graph of return loss against frequency is illustrated for the dual-band splashplate assembly of FIG. 2. Typically, a maximum acceptable return loss at frequencies for which the antenna will be used is about 20 decibels (dB), although the acceptable limit may vary according to the application. For instance, in some cases a return loss of 15 dB may be acceptable. In FIG. 7, design frequencies in the lower and upper bands are shaded for clarity. As shown in FIG. 7, in both the lower and upper bands the return loss is below the acceptable limit of 20 dB. Furthermore, the acceptable regions having return loss below 20 dB extend well beyond the required frequency bands, hence the splashplate assembly of the present embodiment would also be suitable for use with wider frequency bands. Between the upper and lower bands there are return loss peaks around 26 and 27 GHz. These peaks arise due to the mode launcher, and can be moved to a higher or lower frequency by varying the dimensions of the mode launcher and the waveguide feed. Therefore in an embodiment of the present invention that is intended for use at frequencies around 26 GHz, the mode launcher can be adjusted accordingly to ensure that the return loss peak does not fall within a desired transmission band, by changing the dimensions D1 and D2 of FIG. 4 accordingly.

An alternative embodiment of the splashplate support is illustrated in FIGS. 8A to 8C. In this embodiment, a splashplate assembly for a reflector antenna includes a waveguide feed 810 and splashplate 830, similar to the waveguide feed and splashplate of FIG. 2. Also, the splashplate support 840 of the present embodiment is similar to that of FIG. 2 in that it comprises a first engaging portion 840a for engaging with an outer surface of the waveguide feed 810, a second engaging portion 840c for engaging with the splashplate 830, and a supporting wall 840b extending between the two engaging portions 840a, 840c. However, unlike the embodiment of FIG. 2, in the present embodiment the supporting wall 840b is linear when viewed in cross-section, instead of curved. Accordingly, the splashplate support 840 of the present embodiment is conical, when viewed in three dimensions. In this embodiment and other embodiments, the wall thickness may be varied along the profile of the supporting wall 840b to optimise the performance.

Although embodiments of the present invention have been described which comprise a continuous wall that connects the engaging portions and encloses a void, i.e. a space that is free of dielectric material, in other embodiments other types of supporting portion may be used. For example, instead of a wall, the first and second engaging portions may be joined by a supporting portion such as one or more dielectric struts, with open space between the struts. That is, in some embodiments the supporting portion may not be formed as a wall, and may not be continuous. FIG. 9 illustrates a splashplate support 940 according to an embodiment of the present invention, in which the supporting portion 940b comprises a plurality of struts connecting the first and second engaging portions 940a, 940c. As with the supporting wall in the embodiments of FIGS. 2, 3A to 3C and 8A to 8C, the struts 940b of the present embodiment are arranged to define a space between the aperture and the splashplate.

Embodiments of the present invention have been described which can allow dual-band operation with splashplate-type reflector antennas, as a splashplate support is arranged to define a space between the waveguide feed aperture and the splashplate. Since the space defined by the support includes the path taken by a beam of electromagnetic radiation from the aperture to the splashplate, the beam's path is not obstructed by the support. Therefore frequencies in both the upper and lower bands are unaffected by the presence of the support. In contrast, dual-band operation has not been possible with conventional splashplate supports and waveguide feeds. Embodiments of the present invention may be used in both circular polarisation and linear polarisation applications.

Furthermore, although embodiments of the present invention have been described in which the waveguide feed is circular in cross-section, the invention is not limited to this arrangement. Other cross-sections with some radial symmetry can be used, for instance in some embodiments the waveguide feed horn can have a square cross-section and the splashplate support can similarly have a square cross-section.

Additionally, embodiments of the present invention have been described in which the waveguide feed includes a mode launcher that has a larger internal diameter nearer the aperture than at the input to the waveguide feed. This ensures that the diameter at the aperture is electrically larger, i.e. corresponds to a greater number of wavelengths, than at the input. However, in some embodiments the internal diameter may not be physically larger near the aperture. For example, the waveguide feed can be made electrically larger at the aperture by inserting a dielectric plug or ring without physically increasing the internal diameter, since the wavelength will be reduced in the dielectric. Hence the mode launcher does not have to be embodied as a change in physical dimensions. This approach would have a detrimental effect on performance, but could nevertheless find use in certain applications, for example where size constraints prevent a larger physical diameter from being used at the aperture.

Also, although embodiments of the present invention have been described in which the splashplate support engages with an outside surface of the waveguide feed, the invention is not limited to this arrangement. In some embodiments, the first engaging portion can be otherwise formed, for example as a thin collar to be inserted into the waveguide aperture. Such an arrangement would degrade the performance to some extent, but may be required in embodiments where space constraints prevent the support from engaging with the outer surface of the waveguide feed.

Whilst certain embodiments of the present invention have been described above, the skilled person will recognise that many variations and modifications are possible, without departing from the scope of the invention as defined in the accompanying claims.

1. A reflector antenna comprising:
a dual-band waveguide feed configured to receive an input signal in a first transmission mode, where the input signal can include a plurality of frequencies arranged into upper and lower frequency bands, and the waveguide feed including a mode converter configured for converting a transmission mode of an upper frequency band from the first transmission mode to a mixed transmission mode including the first transmission mode and a second transmission mode;
a reflector;
a splashplate configured to direct a beam emitted from an aperture of the waveguide feed to the reflector; and
a splashplate support comprising having a first engaging portion for engaging with the waveguide feed, a second engaging portion for engaging with the splashplate, and a supporting portion connecting the first engaging portion to the second engaging portion and arranged to define a space between the waveguide feed aperture and the splashplate.

2. The reflector antenna of claim 1, wherein the supporting portion will be spaced apart from the aperture of the waveguide feed in a direction away from the splashplate, when the first engaging portion is engaged with the waveguide feed.

3. The reflector antenna of claim 1, wherein the supporting portion has a thickness less than or equal to substantially λ/2, where λ is a characteristic wavelength of a beam inside the supporting portion.

4. The reflector antenna of claim 3, wherein the characteristic wavelength is a wavelength corresponding to a centre frequency of a transmission band of a beam when emitted from the aperture of the waveguide feed, or is an average wavelength of the beam, or is a value between the average wavelength and the wavelength corresponding to the centre frequency.

5. The reflector antenna of claim 1, wherein the supporting portion has a shape corresponding to a wavefront of a beam when emitted from the waveguide feed after it has been reflected from the splashplate.

6. The reflector antenna of claim 1, wherein the supporting portion is curved or elliptical in cross-section.

7. The reflector antenna of claim 1, wherein the supporting portion is a substantially continuous wall.

8. The reflector antenna of claim 1, wherein the first engaging portion is configured to engage with an outer surface of the waveguide feed.

9. The reflector antenna of claim 1, wherein the splashplate support is formed of polytetrafluoroethylene PTFE.

10. The reflector antenna of claim 1, wherein the mode converter is spaced apart from the aperture by a predetermined distance, such that for the upper band both the first and second transmission modes are substantially in phase at the aperture.

11. The reflector antenna of claim 1, wherein the mode converter comprises:
a taper, one or more steps, or a profiled change in an internal diameter of the waveguide feed, and connects a section of a first diameter D₁ to a section of a second diameter D₂, wherein the second diameter is greater than the first diameter.

12. The reflector antenna of claim 1, wherein the first transmission mode is a TE₁₁ mode and the second transmission mode is a TM₁₁ mode.

13. The reflector antenna of claim 1, wherein the waveguide feed is circular in cross-section, and wherein a diameter of the aperture is substantially one wavelength of a frequency in the lower frequency band.

14. The reflector antenna of claim 1, wherein the waveguide feed is configured for use at Ka band frequencies.

15. A satellite comprising:
a satellite body; and
the reflector antenna of claim 1.
